(19) United States
(12) Patent Application Publication
(10) Pub. No.: US 2026/0253300 A1
(43) Pub. Date: Aug. 27, 2026

(54) PHYSICS-BASED HUMAN MOTION MODELING FOR NOISY MOTION-CAPTURE DATA USING POLICY NETWORK

(71) Applicants: SONY GROUP CORPORATION, TOKYO (JP); SONY CORPORATION OF AMERICA, NEW YORK, NY (US)

(72) Inventors: YINGRUO FAN, MOUNTAIN VIEW, CA (US); SUJEET KUMAR GANDHI, SAN MATEO, CA (US); SELIM ENGIN, WEEHAWKEN, NJ (US); AKIRA NAKAMURA, SAN JOSE, CA (US)

(21) Appl. No.: 19/259,507

(22) Filed: Jul. 3, 2025

Related U.S. Application Data
(60) Provisional application No. 63/762,974, filed on Feb. 25, 2025.

(51) Int. Cl. G06T 13/40; G06N 3/092; G06T 17/00

(52) U.S. Cl. CPC G06T 13/40; G06N 3/092; G06T 17/00

(57) ABSTRACT

An electronic device and method for physics-based human motion modeling for noisy motion-capture data using policy network is disclosed. A first humanoid model, associated with a baseline three-dimensional (3D) human pose and motion-capture data associated with the first humanoid model, is received. A policy network is applied on the first humanoid model and the motion-capture data, based on noise data associated with the motion-capture data. A humanoid action associated with the motion-capture data is determined, based on the applied policy network. The humanoid action corresponds to a set of joint-motion parameters associated with the motion-capture data. A state model associated with the humanoid action is determined, based on a motion filter and the policy network is trained based on the state model. The motion filter is configured to predict physics-based kinematics information of the motion-capture data, based on the trained policy network.

### CROSS-REFERENCE TO RELATED APPLICATIONS/INCORPORATION BY REFERENCE

This patent application makes reference to, claims priority to, and claims the benefit of U.S. Provisional Application No. 63/762,974, filed Feb. 25, 2025, the contents of which are hereby incorporated herein by reference in its entirety.

### FIELD

Various embodiments of the disclosure relate to human motion modeling. More specifically, various embodiments of the disclosure relate to an electronic device and a method for physics-based human motion modeling for noisy motion-capture data using policy network.

### BACKGROUND

Human motion generation play crucial role in sports, broadcasting, virtual reality, filmmaking, animation, gaming, robotics, and the like. Most of the method focus on kinematics-based human motion generation and physics-based human motion generation. The kinematics-based methods are employed to generate human motion by animating joint positions and rotations. The kinematics-based methods animate motion by focusing on joint positions and rotations, without considering the underlying physical forces or constraints. As a result, kinematics-based approaches often fail to address issues such as collision detection, contact forces, and the range of motion for each joint, leading to artifacts like ground penetration and foot sliding. Also, many approaches exhibit temporal jitters when performing per-frame pose estimations. Typically, the interaction between the human and the environment is completely disregarded, resulting in collision violations, such as ground penetration or foot sliding.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for physics-based human motion modeling for noisy motion-capture data using policy network is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for physics-based human motion modeling for noisy motion-capture data using policy network, in accordance with an embodiment of the disclosure.

FIG. 2 is a block diagram that illustrates an electronic device for physics-based human motion modeling for noisy motion-capture data using the policy network, in accordance with an embodiment of the disclosure.

FIG. 3 is a diagram that illustrates an execution pipeline including operations for physics-based human motion modeling for noisy motion-capture data using policy network, in accordance with an embodiment of the disclosure.

FIG. 4 is an architecture diagram of a policy network for physics-based human motion modeling for noisy motion-capture data, in accordance with an embodiment of the disclosure.

FIG. 5 is an exemplary diagram of a scenario for motion filter for physics-based human motion modeling for noisy motion-capture data using policy network, in accordance with an embodiment of the disclosure.

FIG. 6 is a flowchart illustrating an example method physics-based human motion modeling for noisy motion-capture data using policy network, in accordance with an embodiment of the disclosure.

### DETAILED DESCRIPTION

The following described implementations may be found in a disclosed electronic device and a method for physics-based human motion modeling for noisy motion-capture data using policy network. Exemplary aspects of the disclosure may provide an electronic device that may receive a first humanoid model associated with a baseline three-dimensional (3D) human pose and motion-capture data associated with the first humanoid model. The electronic device may apply a policy network on the received first humanoid model and the received motion-capture data, based on the noise data associated with the motion-capture data. The electronic device may determine a humanoid action associated with the received motion-capture data, based on the application of the policy network. The determined humanoid action may correspond to a set of joint-motion parameters associated with the received motion-capture data. The electronic device may determine a state model associated with the determined humanoid action, based on a motion filter. The policy network may be trained based on the determined state model. The motion filter may be configured to predict physics-based kinematics information of the received motion-capture data, based on the trained policy network.

The disclosed technology relates to physics-based human motion modeling for noisy motion-capture data using a policy network. In some cases, the technology may address limitations of existing kinematics-based and physics-based methods for human motion generation. Kinematics-based methods for human motion generation may focus on animation of movements based on specification of joint positions and rotations of a humanoid model. These methods may not consider physical constraints such as collision detection, contact forces, or natural ranges of motion for joints. As a result, kinematics-based methods may produce unrealistic artifacts, such as unnatural foot sliding or limb penetration through surfaces.

Physics-based methods may aim to create more realistic and physically plausible motions based on incorporation of physical principles and constraints. These methods may simulate forces and interactions that occur in the real world, such as gravity, friction, and contact forces. However, achieving realistic human motion with physics-based methods may present challenges. A common issue may be that physically simulated humanoids lose balance and fall when subjected to disturbances, such as sudden environmental changes or unexpected forces.

The disclosed technology may combine aspects of both kinematics-based and physics-based approaches. A policy network may be applied to process and refine motion-capture data, and potentially handle inaccuracies or imperfections in the data. The technology may incorporate noise data to help mitigate issues in the motion-capture data, potentially lead to more robust motion generation. A motion filter may be used to determine a state model associated with humanoid actions. This may help refine the actions based on a consideration of physical constraints and dynamics, that potentially enhances realism and physical plausibility of generated motions. The policy network may be trained based on the determined state model. In some cases, the motion filter may be configured to predict physics-based kinematics information of the received motion-capture data, based on the trained policy network. This may further improve accuracy and reliability of the motion generation process.

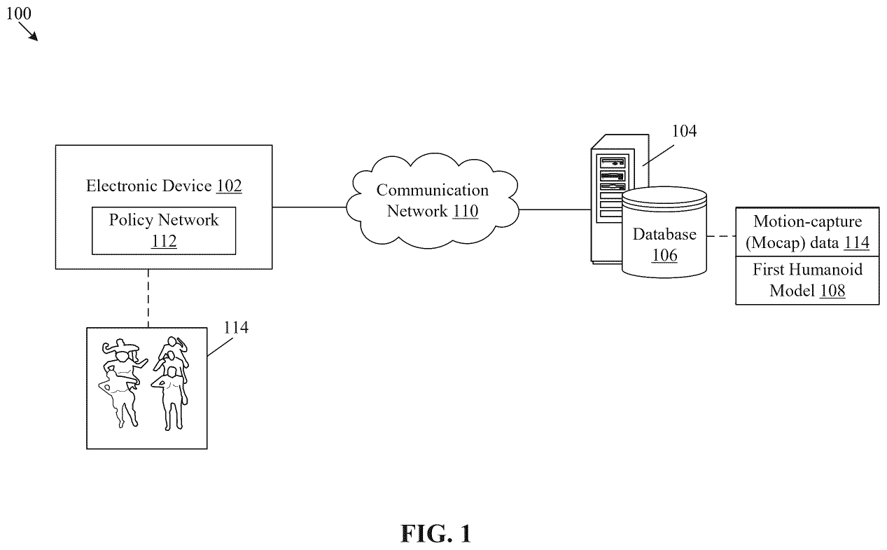

FIG. 1 is a block diagram that illustrates an exemplary network environment for physics-based human motion modeling for noisy motion-capture data using policy network, in accordance with an embodiment of the disclosure. With reference to FIG. 1, there is shown a block diagram of a network environment 100. The network environment 100 may include an electronic device 102, a server 104, a database 106, and a communication network 110. The electronic device 102 may include a policy network 112. The electronic device 102 may receive motion-capture data 114. The server 104 may include the database 106. The electronic device 102, the server 104, and the database 106, may be communicatively coupled to the communication network 110. FIG. 1 also shows a first humanoid model 108. The database 106 may store the motion-capture data 114 and the first humanoid model 108.

The electronic device 102 may include suitable logic, circuitry, interfaces, and/or code that may be configured to receive the first humanoid model 108, which may be associated with a baseline 3D human pose and the motion-capture data 114. The electronic device 102 may apply the policy network 112 on the received first humanoid model 108 and the received motion-capture data 114, based on noise data associated with the motion-capture data 114. A humanoid action associated with the received motion-capture data 114 may be determined. Further, a state model associated with the determined humanoid action may be determined to train the policy network 112. Examples of the electronic device 102 may include, but is not limited to, a desktop, a tablet, a television (TV), a laptop, a computing device, a smartphone, a cellular phone, a mobile phone, a machine-learning (ML) enabled device (that may host an ML model), a consumer electronic (CE) device having a display.

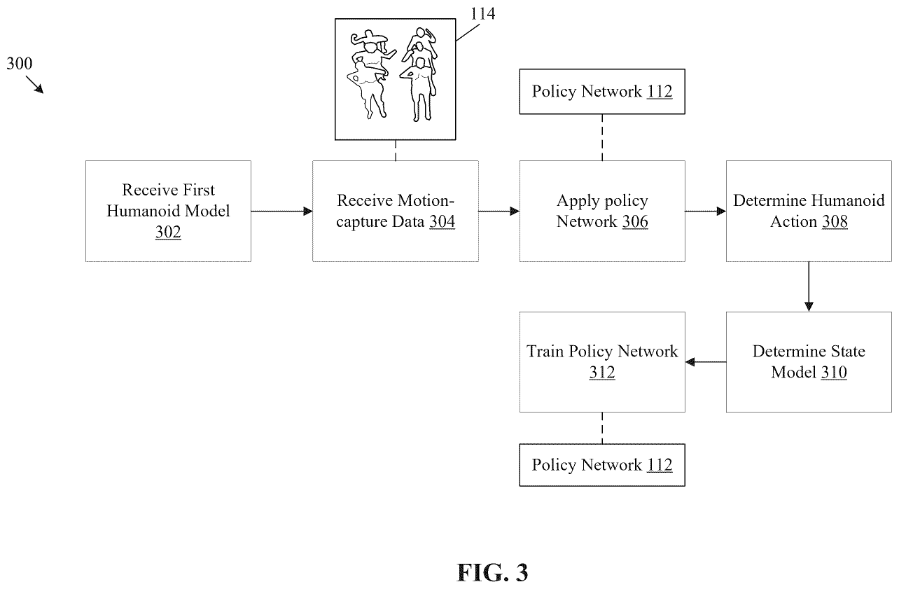

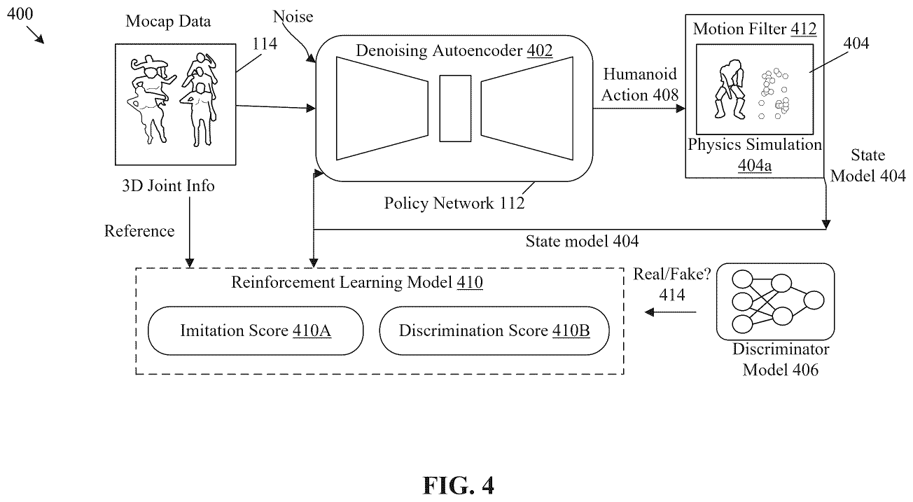

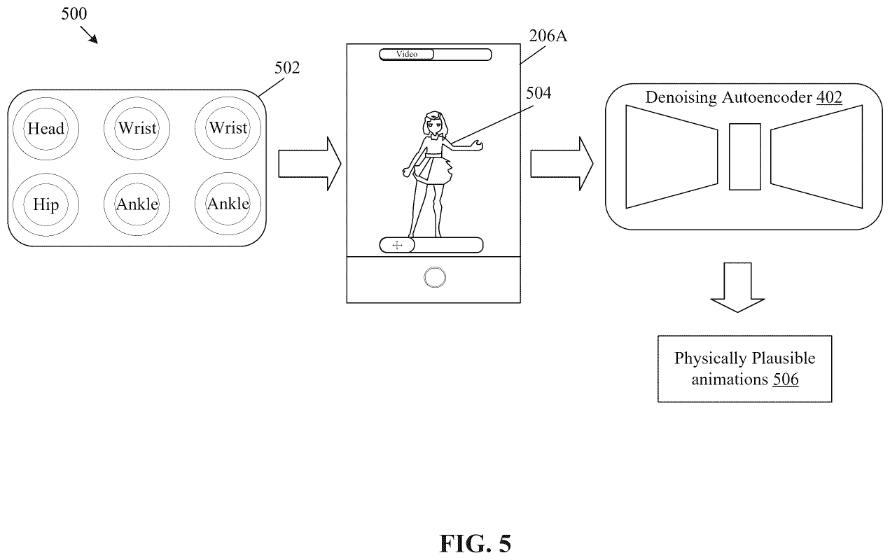

The server 104 that may include suitable logic, circuitry, interfaces, and/or code configured to receive the first humanoid model 108 and the motion-capture data 114, for example, from the electronic device 102 or the database 106. The server 104 may be configured to determine the humanoid action associated with the motion-capture data 114. The server 104 may further determine the state model associated with the determined humanoid action. The server 104 may be configured to train the policy network 112 based on the determined state model. The training of the policy network is explained further in detail, for example, in FIG. 3, FIG. 4, and FIG. 5.

The server 104 may execute operations through web applications, cloud applications, HTTP requests, repository operations, file transfer, and the like. Example implementations of the servers 104 may include, but are not limited to, a database server, a file server, a web server, an application server, a mainframe server, a cloud computing server, or a combination thereof.

The database 106 may include suitable logic, circuitry, interfaces, and/or code configured to store information such as the first humanoid model 108 and the motion-capture data 114 associated with the first humanoid model 108. Further, the database 106 may store instructions associated with operation of the electronic device 102. For example, the database 106 may store the policy network 112, information related to the humanoid action, and information related to the state model. The database 106 may be stored or cached on a device or server, such as the server 104. The device storing the database 106 may be configured to query the database 106 for certain information such as, the humanoid action and the state model. The device storing the database 106 may be configured to query the database 106 for the physics-based kinematics information of the motion-capture data 114. In response, the device storing the database 106 may be configured to receive physics-based kinematics information of the motion-capture data 114. In some cases, the device storing the database 106 may receive a query for the first humanoid model 108 and/or the motion-capture data 114 from the electronic device 102. Based on reception of such a query, the device storing the database 106 may retrieve information related to the first humanoid model 108 and/or the motion-capture data 114 and transmit the retrieved information to the electronic device 102.

In some embodiments, the database 106 may be hosted on the server 104 located at same or different locations. The operations of the database 106 may be implemented using hardware including a processor, a microprocessor (e.g., to perform or control performance of one or more operations), a field-programmable gate array (FPGA), or an application-specific integrated circuit (ASIC). In some other instances, the database 106 may be implemented using software.

The first humanoid model 108 may represent a digital representation of a human body, which incorporates a skeletal structure and associated soft tissue components. The first humanoid model 108 may be designed to accurately simulate human anatomy and biomechanics, potentially including detailed representations of joints, muscles, and skin. In some cases, the first humanoid model 108 may be used for various applications in computer graphics, animation, biomechanics research, and motion analysis. The first humanoid model 108 may serve as a template for application of the motion-capture data 114, that may allow realistic human motion simulation in virtual environments. It may also be utilized in medical applications, such as surgical planning or physiotherapy simulations.

Information associated with the first humanoid model 108 may include skeletal structure data, joint hierarchies, muscle attachment points, and skin deformation parameters. The first humanoid model 108 may also incorporate physical properties such as mass distribution, center of gravity, and joint range of motion limits. In some implementations, the first humanoid model 108 may include texture and material properties for realistic rendering. The process of generation of the first humanoid model 108 may involve data acquisition from real human subjects by use of techniques such as 3D scanning, motion capture, and medical imaging. The acquired data may then be processed and refined to create a digital representation of the human body as a humanoid model (e.g., the first humanoid model 108). In some cases, artists and animators may further refine the humanoid model to enhance visual fidelity or adapt the humanoid model for specific applications.

The first humanoid model 108 may be used in various contexts, including entertainment, scientific research, and industrial applications. In the entertainment industry, it may serve as a base model for creating characters in films, video games, and virtual reality experiences. In scientific research, the model may be used to study human biomechanics, ergonomics, or to simulate the effects of various physical conditions on the human body.

The communication network 110 may include a communication medium through which the electronic device 102, and the server 104 may communicate with each other. The communication network 110 may be a wired or wireless network. Examples of the communication network 110 may include, but are not limited to, Internet, a cloud network, Cellular or Wireless Mobile Network (such as Long-Term Evolution and 5^{th} Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The policy network 112 may be a neural network model used to predict and control human motion. The neural network model may be a part of a reinforcement learning model where the policy network 112 learns to map states (e.g., positions, velocities, and other motion-related features) to actions (e.g., joint movements or control signals) that result in smooth and realistic human motion. The policy network 112 may be trained using a combination of supervised learning and reinforcement learning model. The policy network 112 aims to optimize a policy that minimizes the difference between the predicted motion and the desired motion of the humanoid model (for example, second humanoid model), and also ensure that the generated motion adheres to physical constraints and appears natural. The policy network 112 may be trained using a proximal policy optimization (PPO) technique.

The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

The neural network may include electronic data, which may be implemented as, for example, a software component of an application executable on the electronic device 102. The neural network may rely on libraries, external scripts, or other logic/instructions for execution by a processing device, such as the circuitry. The neural network may include code and routines configured to enable a computing device, such as circuitry to perform one or more operations for training the policy network 112 and to predict physics-based kinematics information of the received motion-capture data 114. Additionally, or alternatively, the neural network may be implemented using hardware including a circuitry, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

The motion-capture data 114 may include information such as 3D joint positions, joint rotations, velocities, and accelerations captured over time for one or more human subjects. In some implementations, the motion-capture data 114 may also encompass ground reaction forces, muscle activations, or even physiological parameters like heart rate or skin conductance. In an embodiment, the received motion-capture data 114 corresponds to 3D joint-motion information of a human subject.

The motion-capture data 114 may be stored in various formats, such as a BVH (Bio-Vision Hierarchy) format, a C3D (Coordinate 3D) format, or a custom JSON structure, in the database 106 or locally on the electronic device 102. Example parameters within the motion-capture data 114 may include, but are not limited to, joint angles (e.g., knee flexion angle, elbow rotation), positional coordinates of body landmarks (e.g., wrist position in 3D space), angular velocities of limb segments, or center of mass trajectories. The motion-capture data 114 may serve as input for the policy network 112, which may process and refine the input to generate physically plausible animations. The motion-capture data 114 may be used to train the policy network 112 and allow the policy network 112 to learn patterns and dynamics of human movement. Additionally, the motion-capture data 114 may be utilized by a motion filter to predict physics-based kinematics information, to potentially enhance the realism of the generated motions.

The motion-capture data 114 may be collected by use of a variety of techniques and sensors to record the movement of human subjects. In some cases, the electronic device 102 may use optical motion capture systems including multiple cameras to track reflective markers placed on key points of a user's body. Further, the electronic device 102 may use inertial measurement units (IMUs) to capture rotational and acceleration data of body segments. Further, the electronic device 102 may use depth cameras, such as those used in consumer-grade motion sensing devices, to collect 3D point cloud data of a subject's movements.

In operation, the electronic device 102 may be configured to receive the first humanoid model 108 associated with the baseline 3D human pose and the motion-capture data 114 associated with the first humanoid model 108. A humanoid model (for example, the first humanoid model 108) may refer to computational or physical representation of a human body, designed to mimic human anatomy and movement. The humanoid model may be used in various fields such as robotics, animation, biomechanics, and ergonomics. The motion-capture data 114 may refer to predefined or recorded movements of the human body that serve as a reference to analyze or replicate human motion. These motions may be captured using MoCap technology, which records the positions and orientations of various body parts over time. The data collected may then be used to analyze human movement, improve the design of humanoid robots, or create realistic animations in films and video games. The motion-capture data 114 may be used to record and analyze the movement of human actors. The human actor movements may be captured and used as the basis for generation or refinement of digital animations or simulations, such as a second humanoid models. The data may be applied on the humanoid models to create realistic animations for various applications, such as video games, movies, virtual reality, and robotics. In an embodiment, given an input reference motion or the motion-capture data 114, the goal for the first humanoid model 108 may be to imitate the human motion (that is human actor's motion) as closely as possible, based on physics rules and constraints.

In an embodiment, the electronic device 102 may apply the policy network 112 on the received first humanoid model 108 and the received motion-capture data 114, based on noise data associated with the motion-capture data 114. The training of the policy network 112 is based on a reinforcement learning model including a discrimination score and an imitation score. Based on the reinforce learning (RL) model, a denoising autoencoder (DAE) model may be applied as the policy network 112 to synthesize physically plausible motion in a motion filter or physics simulator. The policy network 112 may be used to imitate the reference motions (such as, MoCap data) based on consideration of physics constraints (for example, collision detection, contact forces, range of motion for each joint, and the like). The motion of the humanoid model may be controlled by applying torques to all joints (for example, set of joint-motion parameters) of the humanoid model. The policy network 112 may output a humanoid action. The policy network 112 may be the type of neural network used in reinforcement learning to map states (e.g., the current pose of the humanoid) to actions (e.g., joint torques or muscle activations). The policy network 112 may be designed with an appropriate architecture, such as input layers for the state, hidden layers for processing, and output layers for actions.

In an embodiment, the electronic device 102 may determine a humanoid action associated with the received motion-capture data 114, based on the application of the policy network 112. The determined humanoid action may correspond to a set of joint-motion parameters associated with the received motion-capture data 114. The output of the policy network 112 may be the humanoid action, which may be converted into torques to be applied to each joint of the first humanoid model 108. The output humanoid action may specify a target of Proportional Derivative (PD) controllers that produce joint torques. The first humanoid model 108 may be simulated in a physics simulator (referred as a motion filter).

In an embodiment, the electronic device 102 may determine a state model associated with the determined humanoid action, based on the motion filter. At each time step, an input to the policy network 112 may include the state model. The state model may include the humanoid proprioception (for example, height, joint positions, joint rotations, linear velocities and angular velocities) and a difference between a reference motion for the next time step and a generated motion for the current time step.

In an embodiment, the electronic device 102 may train the policy network 112 based on the determined state model. The motion filter may be configured to predict physics-based kinematics information of the received motion-capture data 114, based on the trained policy network 112. The DAE model may be utilized as the policy network 112. During training, noise (for example, Gaussian noise) may be added to the motion-capture data 114. The DAE model may learn to synthesize natural motions given input examples with additive noise. All the networks (such as, the policy network 112) may be multilayer perceptron (MLP) neural networks. The policy network 112 may be trained using the proximal policy optimization (PPO) method. The policy network is described further, for example, in FIG. 3, FIG. 4 and FIG. 5.

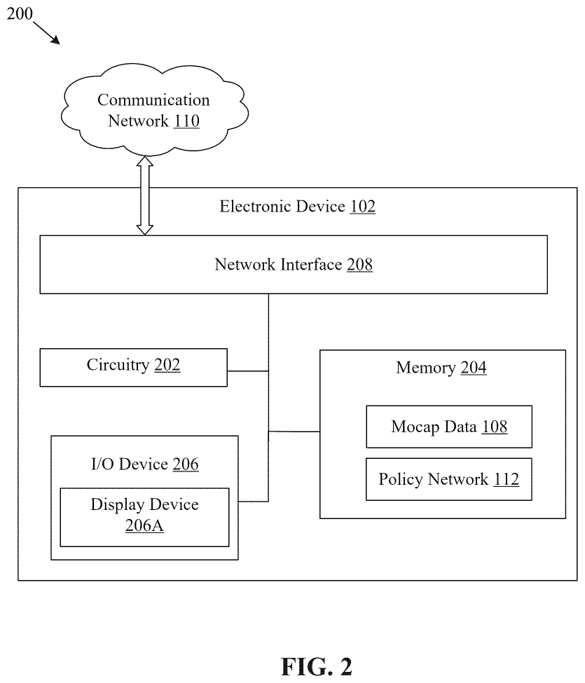

FIG. 2 is a block diagram that illustrates an electronic device for physics-based human motion modeling for noisy motion-capture data using policy network, in accordance with an embodiment of the disclosure. FIG. 2 is explained in conjunction with elements from FIG. 1. With reference to FIG. 2, there is shown a block diagram 200 of the electronic device 102. The electronic device 102 may include a circuitry 202, a memory 204, an input/output (I/O) device 206, and a network interface 208. In at least one embodiment, the I/O device 206 may also include a display device 206A. In at least one embodiment, the memory 204 may include motion-capture data 114 and policy network 112. The circuitry 202 may be communicatively coupled to the memory 204, the I/O device 206, the network interface 208, through wired or wireless communication of the electronic device 102.

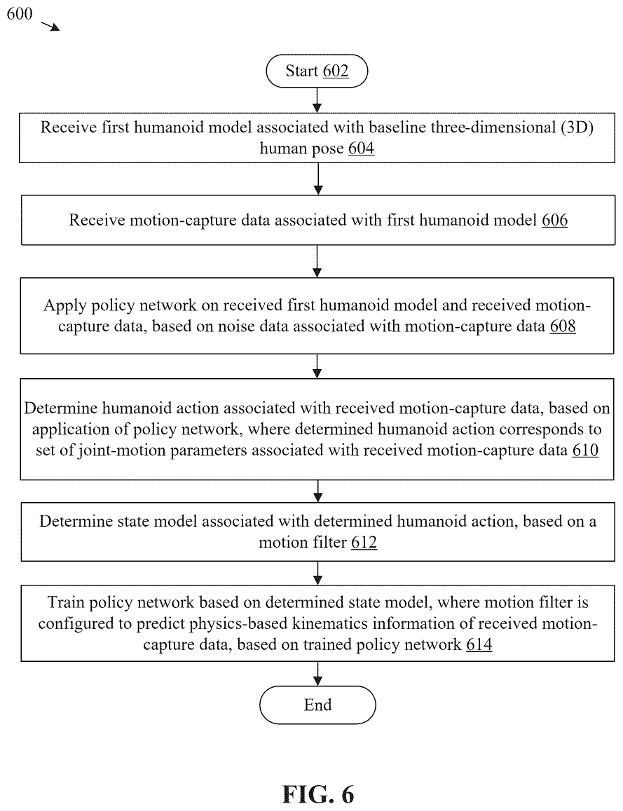

The circuitry 202 may include suitable logic, circuitry, and interfaces that may be configured to execute program instructions associated with different operations to be executed by the electronic device 102. The operations may include reception of the first humanoid model 108 associated with the baseline 3D human pose and motion-capture data 114 associated with the first humanoid model 108. The operations may further include application of the policy network 112 on the received first humanoid model 108 and the received motion-capture data 114. The noise data may be provided to the policy network 112 along with the first humanoid model 108 and motion-capture data 114. The operation may further include the determination of the humanoid action associated with the received motion-capture data 114 based on the application of policy network 112. The determined humanoid action may correspond to a set of joint-motion parameters associated with the received motion-capture data 114. The operation may further include the determination of the state model associated with the determined humanoid action. The policy network 112 may be trained based on the determined state model. The determination of the humanoid action and state model may be further described, for example, in FIG. 3, FIG. 4 and FIG. 6.

The circuitry 202 may include one or more specialized processing units, which may be implemented as an integrated processor or a cluster of processors that perform the functions of the one or more specialized processing units, collectively. The circuitry 202 may be implemented based on a number of processor technologies known in the art. Examples of implementations of the circuitry 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, interfaces, and/or code that may be configured to store the program instructions to be executed by the circuitry 202. The program instructions stored on the memory 204 may enable the circuitry 202 to execute operations of the circuitry 202 (and/or the electronic device 102). In at least one embodiment, the memory 204 may store the motion-capture data 114 and the first humanoid model 108. The memory 204 may store the trained policy network 112. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive multimedia content and provide an output based on the received input. For example, the I/O device 206 may receive the first humanoid model and the motion-capture data 114. Examples of the I/O device 206 may include, but are not limited to, a touch screen, a keyboard, a mouse, a joystick, a microphone, the display device 206A, and a speaker. Examples of the I/O device 206 may further include braille I/O devices, such as, braille keyboards and braille readers.

The I/O device 206 may include the display device 206A. The display device 206A may include suitable logic, circuitry, and interfaces that may be configured to receive inputs from the circuitry 202 to render on a display screen, for example realistic representation of human motion. In at least one embodiment, the display device 206A may be at least one of a resistive touch screen, a capacitive touch screen, or a thermal touch screen. The display device 206A may be realized through several known technologies such as, but not limited to, at least one of a Liquid Crystal Display (LCD) display, a Light Emitting Diode (LED) display, a plasma display, or an Organic LED (OLED) display technology, or other display devices.

The network interface 208 may include suitable logic, circuitry, and interfaces that may be configured to facilitate communication between the circuitry 202, the I/O device 206, and the memory 204, via the communication network 110. The network interface 208 may be implemented by using various known technologies to support wired or wireless communication of the electronic device 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, or a wireless network, such as a cellular telephone network, a wireless local area network (LAN), a short-range network, and a metropolitan area network (MAN). The wireless communication may use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, and a wireless peer-to-peer protocol.

FIG. 3 is a diagram that illustrates an execution pipeline including operations for physics-based human motion modeling for noisy motion-capture data using policy network, in accordance with an embodiment of the disclosure. FIG. 3 is explained in conjunction with elements from FIG. 1 and FIG. 2. With reference to FIG. 3, there is shown an exemplary execution pipeline 300 including operations for physics-based human motion modeling for the (noisy) motion-capture data 114 using policy network 112. The execution pipeline 300 may include operations 302 to 312 executed by a computing device, such as, the electronic device 102 of FIG. 1 or the circuitry 202 of FIG. 2.

At 302, an operation of first humanoid model reception may be performed. The circuitry 202 may be configured to receive the first humanoid model 108 associated with the baseline 3D human pose. The humanoid model (for example, first humanoid model 108) may be received from 3D modeling software, online model libraries, motion-capture systems, 3D scanning, and the like. The first humanoid model 108 may be received based on a 3D human pose of a human subject. The first humanoid model 108 may be constructed with the baseline 3D human pose, which may include 3D coordinates of key body points (for example, head, shoulders, elbows, wrists, hips, knees, and the like). A skeletal representation may be constructed of the human body using the 3D joint positions. A kinematic model of the humanoid may be developed, which includes hierarchical structure of the skeleton. A skinning and rigging methods may be applied on the kinematic model to animate the model and refine the movements. The process transforms the raw 3D joint data into fully articulated and visually coherent humanoid model suitable for various applications such as animation, virtual reality, and motion analysis.

At 304, an operation of reception of motion-capture data associated with the first humanoid model may be performed. The circuitry 202 may be configured to receive the motion-capture data 114 associated with the first humanoid model 108. The motion-capture (MoCap) data 114 may be a digital recording of human movements. This data may capture the positions, orientations, and movements of various body parts over time, typically represented as series of 3D coordinates for key joints. The Motion-capture data 114 may be used in various fields such as animation, gaming, virtual reality, sports analysis, and biomechanics to create realistic and accurate representations of human motion. The motion-capture data 114 may be a digital representation of the human movements captured using optical, inertial, or hybrid systems.

At 306, an operation of policy network application may be performed. The circuitry 202 may be configured to apply the policy network 112 on the received first humanoid model 108 and the received motion-capture data 114, based on the noise data associated with the motion-capture data 114. The DAE model may be used as the policy network 112. The DAE model may be the type of neural network that is specifically designed to remove noises from input data. During the policy network 112 training process, the input data may be partially corrupted by noises in a stochastic way. Given this noisy input data, the DAE model may learn a compressed representation and then reconstruct a clean data (for example, clean 3D pose of humanoid model 108). This process may help reducing the impact of noise and enhance the overall data quality. As shown in FIG. 4, the DAE model may include an encoder and a decoder. The encoder may encode the noisy input into a compressed representation (hidden feature), and then the decoder may reconstruct the original input data (for example, the first humanoid model 108).

The policy network 112 may receive the inputs (for example, first humanoid model 108, motion-capture data 114 along with the noise). The policy network 112 may aim to imitate the motion-capture data 114 (or may be referred as reference motions), while considering physics constrains (such as collision detection contact forces, and the like). The motion of the first humanoid model 108 may be controlled based on application of torques to the set of joint-motion parameters (for example, joint torque information). The output received from the policy network 112 may be the humanoid action.

At 308, an operation of humanoid action determination may be performed. The circuitry 202 may be configured to determine the humanoid action associated with the received motion-capture data 114, based on the application of the policy network 112. The determined humanoid motion may correspond to the set of joint-motion parameters associated with the received motion-capture data 114. A CMU motion-capture dataset may be used for training the policy network 112. In an example, the CMU motion-capture dataset may include diverse motion sequences (around 2000 motion sequences) such as walking, jumping, dancing etc. The humanoid action may be the output from the policy network 112, which may be used to calculate the torque applied on each joint. Each humanoid action may represent the target joint angle. Based on the target joint angle, a proportional-derivative (PD) controller may be used to compute the torques.

At 310, an operation of determination of the state model associated with the determined humanoid action may be performed. The circuitry 202 may be configured to determine the state model associated with the determined humanoid action, based on the motion filter. A discriminator may be applied on the determined state model and the first humanoid model 108, based on the received motion-capture data 114 and a discrimination score may be determined associated with the received motion-capture data 114, based on the application of the discriminator model. An imitation score associated with an imitation of the received motion-capture data 114 by the motion filter may be determined, based on the determined state model. The policy network 112 may be trained based on the determined discriminator score and the determined imitation score of the state model. The imitation score includes, but is not limited to, a joint position score, a joint rotation score, a velocity score, and an angular velocity score. The state model may be mapped with the determined humanoid action to determine the second humanoid model. The policy network 112 may be further trained based on a determined second humanoid model. The state model may include, but is not limited to, a humanoid proprioception model associated with the first humanoid model 108, a difference between the first humanoid model 108 and the second humanoid model, or motion information associated with a current state of the first humanoid model 108. The humanoid proprioception model may include, but not limited to, a root height associated with the first humanoid model 108, joint positions associated with the first humanoid model 108, joint rotations associated with the first humanoid model 108, linear velocities associated with joints of the first humanoid model 108 or angular velocities associated with joints of the first humanoid model 108. In an embodiment, the imitation score and the discrimination score may be defined based on the motion-capture data 114. The imitation score may encourage the simulated humanoid to imitate behaviors from a given reference motion. The discrimination score may improve the naturality of the motion produced from the policy network 112. The imitation score may reduce the difference between the reference motion and the generated motion in terms of the joint position, joint rotation, linear velocity, and angular velocity for each time step and the like. The imitation score may be defined based on equation (1), as follows:

$${R}^{imitation} = {w}_{p} {e}^{- {α}_{p} ‖ \tilde{p} - p ‖} + {w}_{r} {e}^{- {α}_{r} ‖ \tilde{r} - r ‖ \vert} + {w}_{v} {e}^{- {α}_{v} ‖ \tilde{v} - v ‖} + {w}_{a} {e}^{- {α}_{a} ‖ \tilde{a} - a ‖ \vert} \qquad ( 1 )$$

where the equation (1) may include joint position reward, joint rotation reward, velocity reward and angular velocity reward. Here “wₚ”, “wᵣ”, “wᵥ”, “wₐ” may represent weighing factors for each reward. Also, “\tilde{p}” may denote a joint position in reference motion, while “p” may represent a generated joint position. Similarly, for “r” (joint rotation), “v” (linear velocity), and “a” (angular velocity); “αₚ” “αᵣ”, “αᵥ” and “αₐ” may denote additional weighting parameters for respective rewards.

At 312, an operation of policy network training may be performed. The circuitry 202 may be configured to train the policy network 112 based on the determined state model. The motion filter may be configured to predict physics-based kinematics information of the received motion-capture data 114, based on the trained policy network 112. The training of the policy network 112 may be based on the reinforcement learning model including the determined discrimination score and the determined imitation score. The training of the policy network is described further, for example, in FIG. 4.

FIG. 4 is an architecture diagram of a policy network for physics-based human motion modeling for noisy motion-capture data, in accordance with an embodiment of the disclosure. FIG. 4 is explained in conjunction with elements from FIG. 1, FIG. 2, and FIG. 3. With reference to FIG. 4, there is shown the exemplary architecture 400 of the policy network 112. The architecture 400 of the policy network 112 may include a denoising autoencoder (DAE) model 402, a discriminator model 406, a reinforcement learning model 410. The reinforcement learning model 410 may include imitation score 410A and discrimination score 410B.

The motion-capture data 114 may represent the positions and orientations of key joints in the human body over time, captured using motion-capture technology. The humanoid model (for example, the first humanoid model 108) may be a digital representation of the human body with joints and bones that may be animated based on the input joint information. Noise data may be given as an input along with the motion-capture data 114 and the first humanoid model 108 to the policy network 112. The noise data may be the random perturbations added to the input data to simulate real-world imperfections and make the model robust to variations.

The policy network 112 may be designed as the DAE model 402, which aims to reconstruct a humanoid action 408 from the noisy input data. The DAE model 402 may be a type of neural network designed to remove the noise data and reconstruct the first humanoid model 108. The denoising autoencoder model 402 may include an encoder and a decoder. The encoder may be a neural network that processes the noisy input and compresses into lower-dimensional representation called hidden features or latent representation. The encoder may typically include several layers of neurons that progressively reduce the dimensionality of the input data and also capture the essential features from the input data. The hidden features may be the compressed representation of the input data produced by the encoder. The hidden features may capture information about the input data (for example, the first humanoid model 108) while the noise and irrelevant details is discarded. The decoder may be a neural network that takes the hidden features as an input and reconstruct a clean version of the input data (for example, the MoCap data). The decoder may include several layers of the neurons that progressively increase the dimensionality of the hidden features to match the original input data. The reconstructed data may be the output of the decoder, which may be the denoised version of the input data. The reconstruction error may be determined based on the reconstructed data and the original data, which may be the measure of a difference between the reconstructed data and the original data (i.e., the motion-capture data 114). The reconstruction error may be used as a loss function to train the autoencoder. The autoencoder may be optimized to minimize the reconstruction error, which enhances denoising of the input data.

The humanoid action 408 received from the DAE model 402 may be passed through the motion filter 412 (for example, a physics simulator). The motion filter 412 may ensure the reconstructed human motion adheres to the laws of physics. The motion filter 412 may simulate the physical interactions and constraints of an environment around a human body and its interaction with the human body, such as but not limited to, joint limits, balance, and gravity. The motion filter 412 may refine an initial motion generated by the denoising autoencoder model 402 or the policy network 112. The motion filter 412 may adjust the motion of the humanoid action 408 to ensure that the motion complies with the laws of physics in more natural movements. The physics simulator may provide feedback to the denoising autoencoder model 402 or the policy network 112 when the generated motion violates physical constraints. Such a feedback may enable the policy network 112 to produce more realistic outputs in subsequent iterations. The physics constraints may include, but are not limited to, gravity, joint constraints, friction, balance, and stability.

The motion filter 412 may include a physics simulation model 404a, which may generate a state model 404 that includes various components and information related to the humanoid motion. The physics simulation model 404a may be configured to simulate an output state based on the mocap data 114 and a mixture of physics and kinematics that may act on the first humanoid model 108. The state model 404 may comprise, but is not limited to, joint positions and orientations, a skeletal hierarchy representation, muscle activation parameters, center of mass and balance information, and contact point data for interactions with the environment. The state model 404 may be generated based on an extraction of key pose and trajectory features, calculation of dynamic properties like velocities and accelerations, integration of physics simulation results, and an iterative refinement based on a feedback of the policy network 112. For example, in case of a walking motion, the state model 404 may track a foot placement, a hip rotation, and arm swing parameters. Further, in a jumping action, the state model 404 may could include takeoff velocity, airborne pose, and landing impact forces. During object manipulation, the state model 404 may represent hand positions, finger articulation, and applied forces. The state model 404 may serve as a representation of the humanoid's motion state, which may enable the policy network 112 to make decisions for generation of physically plausible animations.

The state model 404 may be provided as the input to discriminator model 406. The discriminator model 406 may be a neural network. The discriminator model 406 may distinguish between motion-capture data 114 and motion generated by the denoising autoencoder model 402 or policy network 112. The discriminator model 406 may assess the reconstructed motion (for example, the state model 404) based on a comparison with the motion-capture data 114 and may provide a score or probability indicative of whether the motion of the humanoid model real or fake (as denoted by 414 and depicted as “real/fake?” in FIG. 4). The discriminator model 406 may be used as an adversarial training setup. The discriminator model 406 may be trained to improve its ability to detect fake (generated) motion, while the DAE model 402 may be trained to produce more realistic motion to fool the discriminator model 406. The feedback (such as, a score signal) from the discriminator model 406 may be given to the reinforcement learning model 410. The feedback from the discriminator model 406 may be used to optimize the policy network 112.

The reinforcement learning model 410 may be a type of machine learning where an agent may learn to make decisions by taking actions in an environment to maximize cumulative scores. In the context of processing noisy motion-capture (MoCap) data to generate the (realistic) humanoid action 408, reinforcement learning model 410 may be used to optimize the policy network 112. The reinforcement learning model 410 may generate actions that may be evaluated through the motion filter 412 and the discriminator model 406. The reinforcement learning model 410 may include an imitation score 410A and a discrimination score 410B. The imitation score 410A may measure a similarity between the generated actions and the (ground truth) motion-capture data 114. The imitation score 410A may be calculated using metrics such as Mean Squared Error (MSE) between the generated joint positions and motion-capture joint positions. The discrimination score 410B may be provided by the discriminator model 406, which evaluates the realism of the generated actions. The policy network 112 may be rewarded for generation of actions that the discriminator model 406 is unable to distinguish from real from fake motion-capture data. The process of generation of new actions may be iterated based on the updated state, physics simulation model 404a, evaluation of the simulator output with the discriminator model 406, calculation of rewards or scores, and update of the policy network 112. The iterations may continue until the policy network 112 consistently generates realistic and physically plausible human motion.

The updated model or a state model 404 outputted from the reinforcement learning model 410 may be used to remap motion from a source skeleton (for example, the first humanoid model 108) to a target skeleton (for example, a second humanoid model). The circuitry 202 may be configured to map the state model 404 associated with the determined humanoid action 408 with the received motion-capture data 114, based on a motion retargeting technique. The second humanoid model may be determined based on the mapping. The policy network 112 may be trained further based on the determined second humanoid model.

For example, the mapping may include operations such as, a joint correspondence, wherein the joints of the source skeleton (i.e., the first humanoid model 108) may be matched to corresponding joints on the target skeleton (i.e., the second humanoid model). In an example, the left elbow joint on the source may be mapped to the left elbow joint on the target. The mapping may further include a pose transfer operation, wherein the joint rotations and positions from the source skeleton may transferred to the target skeleton, based on differences in bone lengths and proportions by scaling and adjusting the motion to fit the target skeleton's dimensions. Other operations involved in the mapping may include, for example, a constraint handling operation to ensure the remapped motion remains physically plausible, a root motion adaptation operation, and a secondary motion adjustment operation. The second humanoid model may be determined based on this mapping process. The policy network 112 may be trained further based on the determined second humanoid model, which may allow it to learn how to generate motions that are suitable for different character proportions and skeletal structures.

In an embodiment, due to the difference between a human actor and the simulated humanoid model (for example, the first humanoid model 108), the first humanoid model 108 may not be able to replicate certain motions performed by the human actors. In this case, the first humanoid model 108 may fall in a physics-based simulation environment (e.g., an environment created by use of the motion filter 412). To mitigate this issue, mixture of kinematics and physics motions may be considered for the hard motion sequence. The addition of the kinematics in the motion filter 412 may be useful to follow physics constraints (for example, restrict the range of rotation for joints to avoid unnatural movements, ensure the humanoid bodies do not penetrate each other, etc.). After the mixture of kinematics and physics motions, a post-processing step may be performed to smoothen a root position and joint rotations.

FIG. 5 is an exemplary diagram of a scenario for motion filter for physics-based human motion modeling for noisy motion-capture data using policy network, in accordance with an embodiment of the disclosure. FIG. 5 is explained in conjunction with elements from FIG. 1, FIG. 2, FIG. 3, and FIG. 4. With reference to FIG. 5, there is shown an exemplary scenario 500 of the policy network 112 that may receive inputs (for example, the motion-capture data 114) from a set of sensors and generate physically plausible animations.

In an embodiment, the motion-capture data 114 may be collected using a set of sensors. The set of sensors may be for example, mocapi sensors 502, as shown in FIG. 5. The mocapi sensors 502 may be attached to a human performer. The motion-capture data 114 may include 3D joint positions and orientations over time. The scenario 500 may include the display device 206A showing an anime girl character 504. The anime girl character 504 may be a digital humanoid model with joints and bones that are animated based on the motion-capture data 114. The motion-capture data 114 collected from the mocapi sensors 502 may include noise and artifacts such as ground penetrations of the anime girl character 504, wherein feet or other body parts of the anime girl character 504 may unnaturally pass through the ground.

The denoising autoencoder model 402 including the encoder may process the noisy input to extract hidden features that capture the essential information about the joint positions. The decoder of the denoising autoencoder model 402 of the may reconstruct the anime girl character's joint positions from the hidden features. The denoised joint positions may be passed to the motion filter 412 to enforce the physical constraints, such as joint limits, balance, and gravity. The state model 404 may be updated for the anime girl character 504 based on the reconstructed joint positions. Controllers associated with the mocapi sensors 502 may be applied to specific joints of the anime girl character 504 to achieve desired positions while maintaining physical plausibility. The updated state model 404 of the anime girl character 504 may be passed through the discriminator model 406. The policy network 112 may be optimized using reinforcement learning model 410, based on a maximization of cumulative scores. The scores may be based on the imitation score 410A and the discrimination score 410B, that may encourage the policy network 112 to generate realistic and physically plausible animations 506.

The disclosed technology relates to physics-based human motion modeling for noisy motion-capture data (e.g., the motion-capture data 114) using a policy network (e.g., the policy network 112). In some cases, the technology may address limitations of existing kinematics-based and physics-based methods for human motion generation. Kinematics-based methods for human motion generation may focus on animation of movements based on specification of joint positions and rotations of a humanoid model. These methods may not consider physical constraints such as collision detection, contact forces, or natural ranges of motion for joints. As a result, kinematics-based methods may produce unrealistic artifacts, such as unnatural foot sliding or limb penetration through surfaces.

Physics-based methods may aim to create more realistic and physically plausible motions based on incorporation of physical principles and constraints. These methods may simulate forces and interactions that occur in the real world, such as gravity, friction, and contact forces. However, achieving realistic human motion with physics-based methods may present challenges. A common issue may be that physically simulated humanoids lose balance and fall when subjected to disturbances, such as sudden environmental changes or unexpected forces.

The disclosed technology may combine aspects of both kinematics-based and physics-based approaches. The policy network 112 may be applied to process and refine the motion-capture data 114, and potentially handle inaccuracies or imperfections in the data. The technology may incorporate noise data to help mitigate issues in the motion-capture data, potentially lead to more robust motion generation. A motion filter (e.g., the motion filter 412) may be used to determine a state model (e.g., the state model 404) associated with humanoid action(s) (e.g., the humanoid action 408). This may help refine the actions based on a consideration of physical constraints and dynamics, that potentially enhances realism and physical plausibility of generated motions. The policy network 112 may be trained based on the determined state model 404. In some cases, the motion filter 412 may be configured to predict physics-based kinematics information of the received motion-capture data 114, based on the trained policy network 112. This may further improve accuracy and reliability of the motion generation process.

It should be noted that the scenario 500 of FIG. 5 is for exemplary purposes and should not be construed as limiting the scope of the disclosure.

FIG. 6 is a flowchart illustrating an example method physics-based human motion modeling for noisy motion-capture data using policy network, in accordance with an embodiment of the disclosure. FIG. 6 is described in conjunction with elements from FIG. 1, FIG. 2, FIG. 3, FIG. 4, and FIG. 5. With reference to FIG. 6, there is shown a flowchart 600. The exemplary method of the flowchart 600 may be executed by any computing system, for example, by the electronic device 102 of FIG. 1. The exemplary method of the flowchart 600 may start at 602 and proceed to 604.

At 604, a first humanoid model associated with a baseline 3D human pose may be received. The circuitry 202 may be configured to receive the first humanoid model 108 associated with the baseline 3D human pose. The humanoid model may be the digital representation of the human body that includes skeletal structure, joints and bones. The first humanoid model 108 may be animated based on the motion-capture data 114 and refined using the motion filter 412 to ensure realistic and physically plausible motion. The reception of the first humanoid model is described further, for example, in FIG. 3.

At 606, motion-capture data associated with the first humanoid model may be received. The circuitry 202 may be configured to receive the motion-capture data 114 associated with the first humanoid model 108. The motion-capture data 114 may be a digital recording of the human movements, capturing the 3D positions and orientations of key joints over time. The motion-capture data 114 may be collected using optical, inertial, or hybrid systems and is used in various applications such as animation, gaming, sports analysis, biomechanics, and robotics. The motion-capture data 114 provides detailed and accurate information about human motion, enabling the creation of realistic and precise animations and analyses. The reception of the motion-capture data is described further, for example, in FIG. 3.

At 608, a policy network may be applied on the received first humanoid model and received motion-capture data, based on noise data associated with the motion-capture data. The circuitry 202 may be configured to apply the policy network 112 on the received first humanoid model 108 and the received motion-capture data 114, based on noise data associated with the motion-capture data 114. The policy network 112 training may be based on the reinforcement learning model 410 including the discrimination score 410B and the imitation score 410A. The imitation score 410A includes at least one of joint position scores, a joint rotation score, a velocity score, or an angular velocity score. The application of the policy network 112 on the first humanoid model 108 may output the humanoid action 408. The policy network 112 may corresponds to the DAE model 402. The policy network 112 may be trained using a proximal policy optimization (PPO) technique. The PPO technique may be the reinforcement learning model 410 that optimizes policies based on constrained updates within a trust region by use of a clipped objective function. The application of the policy network is described further, for example, in FIG. 3 and FIG. 4.

At 610, a humanoid action associated with the received motion-capture data may be determined based on the application of the policy network. The circuitry 202 may be configured to determine the humanoid action 408 associated with the received motion-capture data 114, based on the application of the policy network 112. The determined humanoid action 408 may correspond to a set of joint-motion parameters associated with the received motion-capture data 114. The set of joint-motion parameters may correspond to joint torque information associated with the received motion-capture data 114. The determination of the humanoid action 408 associated with the received motion-capture data 114 may be based on the PD controller. The PD controller may be used to determine humanoid action 408 associated with the received motion-capture data 114 and ensure that the humanoid model's joints follow the target positions and orientations derived from the motion-capture data 114. The PD controller may compute corrective forces or torques based on the error forces and error velocities for each joint, and update of the joint positions to achieve smooth and stable motion. The determination of the humanoid action is described further, for example, in FIG. 3 and FIG. 4.

At 612, a state model associated with the determined humanoid action may be determined, based on the motion filter. The circuitry 202 may be configured to determine the state model 404 associated with the determined humanoid action 408 associated with the motion filter 412. The state model 404 may include information associated with at least one of the humanoid proprioception model associated with the first humanoid model 108, the difference between the first humanoid model 108 and the second humanoid model, or the motion information associated with a current state of the first humanoid model 108. The humanoid proprioception model may correspond to at least one of the root heights associated with the first humanoid model 108, the joint positions associated with the first humanoid model 108, the joint rotations associated with the first humanoid model 108, the linear velocities associated with joints of the first humanoid model 108, or the angular velocities associated with joints of the first humanoid model 108. Further, the state model 404 may be mapped with the received motion-capture data 114, based on the motion retargeting technique. The motion retargeting may be a technique used to transfer motion data from the source character (for example, first humanoid model 108) to the target character (for example, second humanoid model) while preserving the original motion's characteristics and ensuring physical plausibility and visual appeal. The second humanoid model may be determined based on the mapping. The policy network 112 may be trained further based on the determined second humanoid model.

In an embodiment, the discriminator model 406 may be applied on the determined state model 404 and the first humanoid model 108, based on the received motion-capture data 114. The discrimination score 410B may be determined associated with the received motion-capture data 114, based on the application of the discriminator model 406. The imitation score 410A may be determined based on the determined state model 404 associated with the imitation of the received motion-capture data 114 by the motion filter 412. The policy network 112 may be further trained based on the determined discrimination score 410B and the determined imitation score 410A. The determination of the state model is described further, for example, in FIG. 3 and FIG. 4.

At 614, the policy network may be trained based on the determined state model. The circuitry 202 may be configured to train the policy network 112 based on the determined state model 404. The motion filter 412 may be configured to predict physics-based kinematics information of the received motion-capture data 114, based on the trained policy network 112. The training of the policy network is described further, for example, in FIG. 3 and FIG. 4. Control may pass to end.

Although the flowchart 600 is illustrated as discrete operations, such as, 604, 606, 608, 610, 612, and 614, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102). Such instructions may cause the electronic device 102 to perform operations that may include reception of a first humanoid model (e.g., the first humanoid model 108) associated with a baseline 3D human pose and motion-capture data (e.g., the motion-capture data 114) associated with the first humanoid model 108. The operations may further include application of a policy network (e.g., the policy network 112) on the received first humanoid model 108 and the received motion-capture data 114, based on the noise data associated with the motion-capture data 114. The operations may further include determination of a humanoid action associated with the received motion-capture data 114, based on the application of the policy network 112. The determined humanoid action may correspond to a set of joint-motion parameters associated with the received motion-capture data 114. The operation may further include determination of a state model associated with the determined humanoid action, based on a motion filter and the policy network 112 training based on the determined state model. The motion filter may be configured to predict physics-based kinematics information of the received motion-capture data 114, based on the trained policy network 112.

Various embodiments of the disclosure may provide an electronic device (for example, the electronic device 102). The electronic device 102 may include circuitry (e.g., the circuitry 202) and memory (e.g., the memory 204). The circuitry 202 of the electronic device 102 may be configured to receive the first humanoid model 108 associated with a baseline three-dimensional (3D) human pose and the motion-capture data 114 associated with the first humanoid model 108. The circuitry 202 of the electronic device 102 may be further configured to apply the policy network 112 on the received first humanoid model 108 and the received motion-capture data 114, based on noise data associated with the motion-capture data 114 and determine a humanoid action associated with the received motion-capture data 114, based on the application of the policy network 112. The determined humanoid action may correspond to a set of joint-motion parameters associated with the received motion-capture data 114. The circuitry 202 of the electronic device 102 may be further configured to determine a state model associated with the determined humanoid action, based on a motion filter and train the policy network 112 based on the determined state model. The motion filter 412 is configured to predict physics-based kinematics information of the received motion-capture data 114, based on the trained policy network 112.

In an embodiment, the circuitry 202 may be further configured to apply a discriminator model on the determined state model and the first humanoid model 108, based on the received motion-capture data 114. The circuitry 202 may be further configured to determine a discrimination score associated with received motion-capture data 114, based on the application of the discriminator model. The circuitry 202 may be further configured to determine, based on the determined state model, the imitation score associated with an imitation of the received motion-capture data 114 by the motion filter. The policy network 112 may be further trained based on the determined discrimination score and the determined imitation score.

In an embodiment, the training of the policy network 112 may be based on a reinforcement learning model including the determined discrimination score and the determined imitation score.

In an embodiment, the imitation score may include at least one of a joint position score, a joint rotation score, a velocity score, or an angular velocity score.

In an embodiment, the circuitry 202 may be further configured to map the state model associated with the determined humanoid action with the received motion-capture data 114, based on a motion retargeting technique and determine a second humanoid model based on the mapping. The policy network 112 may be trained further based on the determined second humanoid model.

In an embodiment, the state model may include information associated with at least one of a humanoid proprioception model associated with the first humanoid model 108, a difference between the first humanoid model 108 and the second humanoid model, or motion information associated with a current state of the first humanoid model 108.

In an embodiment, the humanoid proprioception model may correspond to at least one of a root height associated with the first humanoid model 108, joint positions associated with the first humanoid model 108, joint rotations associated with the first humanoid model 108, linear velocities associated with joints of the first humanoid model 108, or angular velocities associated with joints of the first humanoid model 108.

In an embodiment, set of joint-motion parameters may correspond to joint torque information associated with the received motion-capture data 114. In an embodiment, the received motion-capture data 114 may correspond to 3D joint-motion information of a human subject.

In an embodiment, the policy network 112 corresponds to a Denoising Auto-Encoder (DAE) model. In an embodiment, the policy network 112 may be trained using a proximal policy optimization (PPO) technique. In an embodiment, the determination of the humanoid action associated with the received motion-capture data 114 may be based on a proportional-derivative (PD) controller.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. An electronic device, comprising:
circuitry configured to:
receive a first humanoid model associated with a baseline three-dimensional (3D) human pose;
receive motion-capture data associated with the first humanoid model;
apply a policy network on the received first humanoid model and the received motion-capture data, based on noise data associated with the motion-capture data;
determine a humanoid action associated with the received motion-capture data, based on the application of the policy network, wherein
the determined humanoid action corresponds to a set of joint-motion parameters associated with the received motion-capture data;
determine a state model associated with the determined humanoid action, based on a motion filter; and
train the policy network based on the determined state model, wherein
the motion filter is configured to predict physics-based kinematics information of the received motion-capture data, based on the trained policy network.

2. The electronic device according to claim 1, wherein the policy network corresponds to a Denoising Auto-Encoder (DAE) model.

3. The electronic device according to claim 1, wherein the circuitry is further configured to:
apply a discriminator model on the determined state model and the first humanoid model, based on the received motion-capture data;
determine a discrimination score associated with received motion-capture data, based on the application of the discriminator model; and
determine, based on the determined state model, an imitation score associated with an imitation of the received motion-capture data by the motion filter, wherein
the trained policy network is further based on the determined discrimination score and the determined imitation score.

4. The electronic device according to claim 3, wherein the policy network is trained based on a reinforcement learning model including the determined discrimination score and the determined imitation score.

5. The electronic device according to claim 3, wherein the imitation score includes at least one of:
a joint position score,
a joint rotation score,
a velocity score, or
an angular velocity score.

6. The electronic device according to claim 1, wherein the motion filter is configured to utilize a mixture of kinematics and physics motions of the first humanoid model.

7. The electronic device according to claim 1, wherein the circuitry is further configured to:
map the state model associated with the determined humanoid action with the received motion capture data, based on a motion retargeting technique; and
determine a second humanoid model based on the mapping, wherein
the policy network is trained further based on the determined second humanoid model.

8. The electronic device according to claim 7, wherein the state model includes information associated with at least one of:
a humanoid proprioception model associated with the first humanoid model,
a difference between the first humanoid model and the second humanoid model, or
motion information associated with a current state of the first humanoid model.

9. The electronic device according to claim 7, wherein the humanoid proprioception model corresponds to at least one of:
a root height associated with the first humanoid model,
joint positions associated with the first humanoid model,
joint rotations associated with the first humanoid model,
linear velocities associated with joints of the first humanoid model, or
angular velocities associated with joints of the first humanoid model.

10. The electronic device according to claim 1, wherein set of joint-motion parameters corresponds to joint torque information associated with the received motion-capture data.

11. The electronic device according to claim 1, wherein the received motion-capture data corresponds to 3D joint-motion information of a human subject.

12. The electronic device according to claim 1, wherein the policy network is trained using a proximal policy optimization (PPO) technique.

13. The electronic device according to claim 1, wherein the determination of the humanoid action associated with the received motion-capture data is based on a proportional-derivative (PD) controller.

14. A method, comprising:
in an electronic device:
receiving a first humanoid model associated with a baseline three-dimensional (3D) human pose;
receiving motion-capture data associated with the first humanoid model;
applying a policy network on the received first humanoid model and the received motion-capture data, based on noise data associated with the motion-capture data;
determining a humanoid action associated with the received motion-capture data, based on the application of the policy network, wherein
the determined humanoid action corresponds to a set of joint-motion parameters associated with the received motion-capture data;
determining a state model associated with the determined humanoid action, based on a motion filter; and
training the policy network based on the determined state model, wherein
the motion filter is configured to predict physics-based kinematics information of the received motion-capture data, based on the trained policy network.

15. The method according to claim 14, further comprising:
applying a discriminator model on the determined state model and the first humanoid model, based on the received motion-capture data;
determining a discrimination score associated with received motion-capture data, based on the application of the discriminator model; and
determining, based on the determined state model, an imitation score associated with an imitation of the received motion-capture data by the motion filter, wherein
the policy network is trained further based on the determined discrimination score and the determined imitation score.

16. The method according to claim 15, wherein the policy network is trained based on a reinforcement learning model including the determined discrimination score and the determined imitation score.

17. The method according to claim 15, wherein the imitation score includes at least one of:
a joint position score,
a joint rotation score,
a velocity score, or
an angular velocity score.

18. The method according to claim 14, further comprising:
mapping the state model associated with the determined humanoid action with the received motion capture data, based on a motion retargeting technique; and
determining a second humanoid model based on the mapping, wherein
the policy network is trained further based on the determined second humanoid model.

19. The method according to claim 18, wherein the state model includes information associated with at least one of:
a humanoid proprioception model associated with the first humanoid model,
a difference between the first humanoid model and the second humanoid model, or
motion information associated with a current state of the first humanoid model.

20. A non-transitory computer-readable medium having stored thereon, computer-executable instructions that when executed by an electronic device, causes the electronic device to execute operations, the operations comprising:
receiving a first humanoid model associated with a baseline three-dimensional (3D) human pose;
receiving motion-capture data associated with the first humanoid model;
applying a policy network on the received first humanoid model and the received motion-capture data, based on noise data associated with the motion-capture data;
determining a humanoid action associated with the received motion-capture data, based on the application of the policy network, wherein
the determined humanoid action corresponds to a set of joint-motion parameters associated with the received motion-capture data;
determining a state model associated with the determined humanoid action, based on a motion filter; and
training the policy network based on the determined state model, wherein
the motion filter is configured to predict physics-based kinematics information of the received motion-capture data, based on the trained policy network.
